(19) United States
(12) Patent Application Publication
(10) Pub. No.: US 2026/0152283 A1
(43) Pub. Date: Jun. 4, 2026

(54) CIRCULAR FINNED COALESCER FOR AIRCRAFT ENVIRONMENTAL CONTROL SYSTEMS

(71) Applicant: Hamilton Sundstrand Corporation, Charlotte, NC (US)

(72) Inventors: Donald E. Army, Enfield, CT (US); Matthew Miller, Enfield, CT (US)

(21) Appl. No.: 18/968,007

(22) Filed: Dec. 4, 2024

(51) Int. Cl. B64D 13/06; B01D 46/00

(52) U.S. Cl. CPC B64D 13/06; B01D 46/003; B64D 2013/0662

(57) ABSTRACT

Aircraft air cycle machines include a first stage turbine, a second stage turbine that receives air from the first stage turbine, and a duct arranged between the first stage turbine and the second stage turbine. A circular finned coalescer is arranged within the duct and includes a central body, a first fin layer wrapped about the central body, a first parting sheet wrapped about the first fin layer, and a second fin layer wrapped about the first parting sheet. Each of the fin layers include a plurality of fin elements and channels are defined between circumferentially adjacent fin elements of each of the first and second fin layers. The channels are tortuous channels such that moisture carried on a flow through the channels will impinge upon surfaces of the fin elements and coalesce into water droplets.

### BACKGROUND

The subject matter disclosed herein generally relates to aircraft machines and, more particularly, to aircraft environmental control systems for supplying conditioned air to an aircraft cabin.

Aircraft are configured with multiple machines that are used to generate power, perform work, generate or treat air or other fluids for use onboard the aircraft, and the like. For example, environmental control systems (ECS) are configured provide a supply of conditioned air to an enclosure, such as an aircraft cabin and/or cockpit. An air cycle machine (ACM) is an integral part of the ECS. Conventional ACMs include one or more turbines that are used to expand an air flow after the air is pretreated. As the airflow passes through the ACM, moisture needs to be removed so that a proper humidity level is maintained within the aircraft enclosure. Accordingly, ACMs (or environmental control systems) are conventionally configured with water separators, water collectors, and the like, which are arranged and configured to remove moisture from an airflow as it passes through the ECS. Typically, the moisture is removed by reducing the temperature of the airflow by means of a heat exchanger or the like and a water separator, where the water carried by the airflow will be formed into droplets (e.g., by condensation, coalescing, etc.). The water is then removed by a water separator and/or water collector, which directs liquid water along one flow path for use, storage, or other purpose (or expelled overboard) and the treated air is directed to the enclosure of the aircraft. Improved water removal mechanisms may help improve aircraft system efficiencies.

### SUMMARY

According to some embodiments, aircraft air cycle machines are provided. The aircraft air cycle machines include a first stage turbine configured to receive and expand air, a second stage turbine configured to receive air from the first stage turbine, a duct arranged between the first stage turbine and the second stage turbine, and a circular finned coalescer arranged within the duct. The circular finned coalescer includes a central body, a first fin layer wrapped about the central body, a first parting sheet wrapped about the first fin layer, and a second fin layer wrapped about the first parting sheet. Each of the first fin layer and the second fin layer include a plurality of fin elements arranged in substantially parallel orientation relative an axis through the central body, and channels are defined between circumferentially adjacent fin elements of the plurality of fin elements of each of the first fin layer and the second fin layer. The channels are tortuous channels such that moisture carried on a flow through the channels will impinge upon surfaces of the fin elements and coalesce into water droplets.

In addition to one or more of the features described herein, or as an alternative, further embodiments of the aircraft air cycle machines may include that the circular finned coalescer further comprises a bullnose element arranged on an inlet end of the central body, the bullnose element configured to direct flow into the channels defined by the first and second fin layers.

In addition to one or more of the features described herein, or as an alternative, further embodiments of the aircraft air cycle machines may include that the circular finned coalescer further comprises a housing, wherein the central body, the first fin layer, the first parting sheet, and the second fin layer are arranged within the housing.

In addition to one or more of the features described herein, or as an alternative, further embodiments of the aircraft air cycle machines may include that the housing is configured to securely fit within the duct.

In addition to one or more of the features described herein, or as an alternative, further embodiments of the aircraft air cycle machines may include that the duct comprises a stop, and wherein the housing is positioned against the stop.

In addition to one or more of the features described herein, or as an alternative, further embodiments of the aircraft air cycle machines may include that the housing is fixedly attached to the duct.

In addition to one or more of the features described herein, or as an alternative, further embodiments of the aircraft air cycle machines may include that the circular finned coalescer further includes a second parting sheet wrapped about the second fin layer and a third fin layer wrapped about the second parting sheet.

In addition to one or more of the features described herein, or as an alternative, further embodiments of the aircraft air cycle machines may include that the circular finned coalescer further includes a housing, wherein the third fin layer is arranged between the second parting sheet and the housing.

In addition to one or more of the features described herein, or as an alternative, further embodiments of the aircraft air cycle machines may include a water collector arranged between the circular finned coalescer and the second stage turbine.

In addition to one or more of the features described herein, or as an alternative, further embodiments of the aircraft air cycle machines may include that each fin layer is formed from a sheet material having a thickness of 0.002-0.004 inch.

In addition to one or more of the features described herein, or as an alternative, further embodiments of the aircraft air cycle machines may include that the parting sheet is formed of a sheet material having a thickness of 0.010-0.020 inch.

According to some embodiments, aircraft environmental control systems are provided. The aircraft environmental control systems include a heat exchanger assembly configured to receive ram air along a first path of the heat exchanger assembly and compressed air along a second path of the heat exchanger assembly, wherein the first path comprises a compressed air inlet on a first heat exchanger, and the compressed air is directed into the compressed air inlet, the compressed air being directed from the first heat exchanger into a second heat exchanger and an air cycle machine configured to receive the compressed air from an outlet of the second heat exchanger. The air cycle machine includes a first stage turbine configured to receive and expand the compressed air received from the second heat exchanger, a second stage turbine configured to receive air from the first stage turbine; a duct arranged between the first stage turbine and the second stage turbine, and a circular finned coalescer arranged within the duct. The circular finned coalescer includes a central body, a first fin layer wrapped about the central body, a first parting sheet wrapped about the first fin layer, and a second fin layer wrapped about the first parting sheet. Each of the first fin layer and the second fin layer include a plurality of fin elements arranged in substantially parallel orientation relative an axis through the central body, and channels are defined between circumferentially adjacent fin elements of the plurality of fin elements of each of the first fin layer and the second fin layer. The channels are tortuous channels such that moisture carried on a flow through the channels will impinge upon surfaces of the fin elements and coalesce into water droplets.

In addition to one or more of the features described herein, or as an alternative, further embodiments of the aircraft environmental control systems may include a water collector arranged between the circular finned coalescer and the second stage turbine.

In addition to one or more of the features described herein, or as an alternative, further embodiments of the aircraft environmental control systems may include that treated air that is output from the second stage turbine is directed to an enclosure of an aircraft.

In addition to one or more of the features described herein, or as an alternative, further embodiments of the aircraft environmental control systems may include that the enclosure is one of a cockpit and a cabin of the aircraft.

In addition to one or more of the features described herein, or as an alternative, further embodiments of the aircraft environmental control systems may include that the circular finned coalescer further comprises a bullnose element arranged on an inlet end of the central body, the bullnose element configured to direct flow into the channels defined by the first and second fin layers.

In addition to one or more of the features described herein, or as an alternative, further embodiments of the aircraft environmental control systems may include that the circular finned coalescer further comprises a housing, wherein the central body, the first fin layer, the first parting sheet, and the second fin layer are arranged within the housing.

In addition to one or more of the features described herein, or as an alternative, further embodiments of the aircraft environmental control systems may include that the circular finned coalescer further includes a second parting sheet wrapped about the second fin layer and a third fin layer wrapped about the second parting sheet.

In addition to one or more of the features described herein, or as an alternative, further embodiments of the aircraft environmental control systems may include that each fin layer is formed from a sheet material having a thickness of 0.002-0.004 inch.

In addition to one or more of the features described herein, or as an alternative, further embodiments of the aircraft environmental control systems may include that the parting sheet is formed of a sheet material having a thickness of 0.010-0.020 inch.

The foregoing features and elements may be combined in various combinations without exclusivity, unless expressly indicated otherwise. Features which are described in the context of separate aspects and embodiments may be used together and/or be interchangeable. Similarly, features described in the context of a single embodiment may also be provided separately or in any suitable subcombination. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic diagram of an environmental control system that may incorporate embodiments of the present disclosure;

FIG. 1B is a schematic illustration of a mechanical embodiment of the environmental control system shown in FIG. 1A;

FIG. 2 is a schematic illustration of a portion of an environmental control system in accordance with an embodiment of the present disclosure;

FIG. 3A is an inlet-end illustration of a circular finned coalescer in accordance with an embodiment of the present disclosure;

FIG. 3B is a cross-sectional illustration of the circular finned coalescer of FIG. 3A viewed along the line 3B shown in FIG. 3A;

FIG. 4A is an inlet-end illustration of another circular finned coalescer in accordance with an embodiment of the present disclosure;

FIG. 4B is an outlet-end illustration of the circular finned coalescer of FIG. 4A;

FIG. 4C is an exploded view illustration of the circular finned coalescer of FIG. 4A;

FIG. 5A is a side view of a portion of a circular finned coalescer in accordance with an embodiment of the present disclosure;

FIG. 5B is an enlarged illustration of the region of the circular finned coalescer labeled 5B shown in FIG. 5A;

FIG. 5C is a schematic illustration of one fin layer of the circular finned coalescer of FIG. 5A;

FIG. 6 is a schematic illustration of a portion of an environmental control system of an aircraft in accordance with the present disclosure; and

FIG. 7 is a schematic illustration of another configuration of a fin element arrangement of a circular finned coalescer in accordance with an embodiment of the present disclosure.

### DETAILED DESCRIPTION

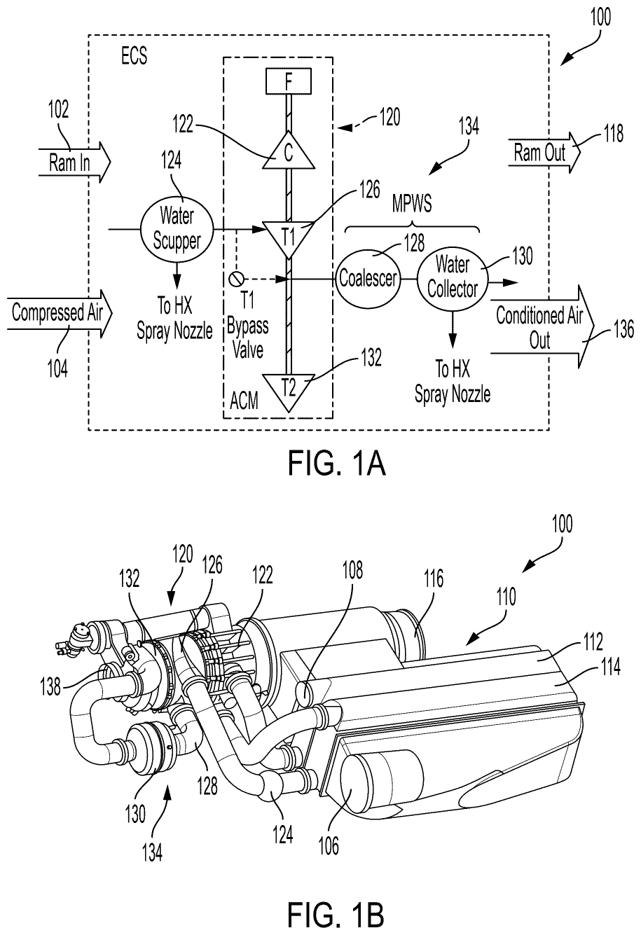

Referring to FIGS. 1A-1B, schematic illustrations of a portion of an aircraft environmental control system (ECS) 100 that may incorporate embodiments of the present disclosure are shown. FIG. 1A is a schematic diagram of the ECS 100 and FIG. 1B is a structural illustration of one configuration of the ECS 100. The ECS 100 is configured to supply conditioned air to an enclosure or space of an aircraft, such as an aircraft cabin and/or cockpit. As shown, the ECS 100 may receive input ram air 102 and input compressed air 104. The input ram air 102 may enter the ECS 100 at a ram air inlet 106 and the input compressed air 104 may enter the ECS 100 at a compressed air inlet 108. The input ram air 102 and the input compressed air 104 may be thermally coupled within a heat exchanger assembly 110. The compressed air may be pre-conditioned within the heat exchanger assembly 110 within a first heat exchanger 112 and a second heat exchanger 114 that are arranged between the ram air inlet 106 and a ram air outlet 116. The ram air may exit the ECS 100 as output ram air 118. The compressed air is first treated within the heat exchanger assembly 110 and an air cycle machine (ACM) 120.

In operation the input compressed air 104 enters the first heat exchanger 112 of the heat exchanger assembly 110, where the compressed air is partially treated by the ram air passing through the heat exchanger assembly 110. The partially treated air exits the first heat exchanger 112 and is directed into a compressor 122 of the ACM 120. The partially treated air is compressed within the compressor 122 of the ACM 120 and then directed into the second heat exchanger 114 of the heat exchanger assembly 110. The air is then directed out of the second heat exchanger 114, through a water scupper 124 and into a first stage turbine 126 of the ACM 120. The partially treated and compressed air is expanded within or across the first stage turbine 126, and then directed through a coalescer 128, passed through a water collector 130, and into a second stage turbine 132 of the ACM 120.

The coalescer 128 and the water collector 130 define a mid-pressure water collector assembly 134. The mid-pressure water collector assembly 134 is arranged between the first stage turbine 126 and the second stage turbine 132 of the ACM 120, and thus is arranged at a mid-pressure level, which is after expansion within the first stage turbine 126 but before further (or second) expansion within the second stage turbine 132. After the second expansion within the second stage turbine 132, conditioned air 136 is directed out of the ECS 100 via a conditioned air outlet 138. The mid-pressure water collector assembly 134 is configured to coalesce fog or moisture from the partially conditioned air that is output from the first stage turbine 126. Accordingly, the mid-pressure water collector assembly 134 is configured to remove free moisture from the airflow as it passes through the ACM 120.

Embodiments of the present disclosure are directed to the mid-pressure water collector assembly 134 incorporating internal features to aid in the removal of moisture from the airflow through the ACM 120. More particularly, embodiments of the present disclosure are directed to a coalescer configuration that is arranged between the output of the first stage turbine 126 and the water collector 130 of the mid-pressure water collector assembly 134. In accordance with embodiments of the present disclosure, an internal structure in the form of a circular finned coalescer is provided within a section of piping or conduit to aid in the removal of water droplets and free moisture in the airflow prior to final processing and expansion within the second stage turbine 132 and then subsequent delivery to a space to be provided with the conditioned air 136.

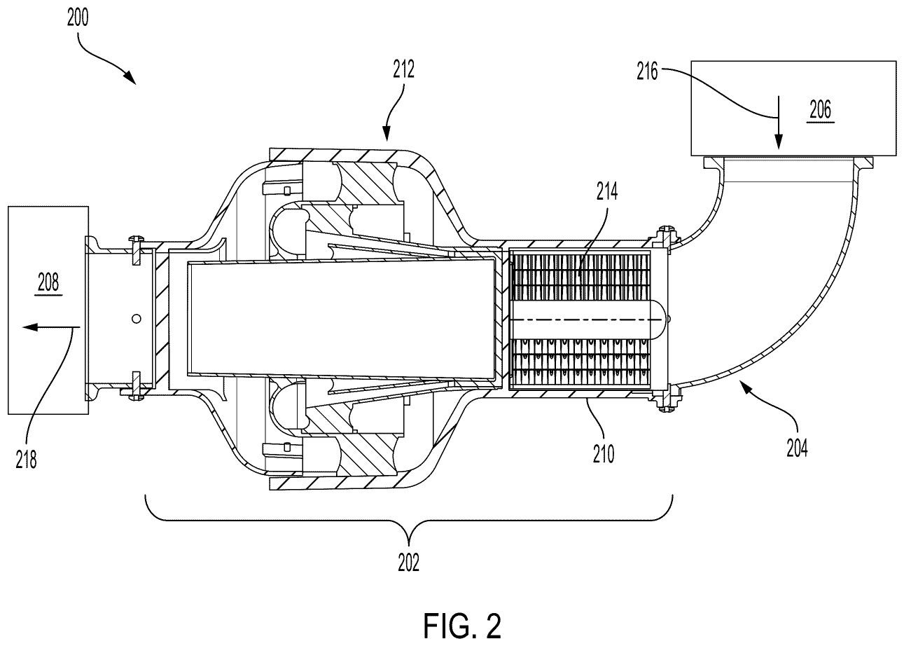

Referring now to FIG. 2, a schematic illustration of a portion of an ECS 200 in accordance with an embodiment of the present disclosure is shown. The ECS 200 may be similar to that shown and described above, and the illustration of FIG. 2 is an enlarged detailed illustration of a mid-pressure water collector assembly 202 of the ECS 200. The mid-pressure water collector assembly 202 is arranged along a duct 204 that fluidly connects a first stage turbine 206 with a second stage turbine 208. The duct 204 includes a straight section 210 and a water separator 212 arranged within the duct 204 and downstream from the straight section 210. The water separator 212 may be configured as a centrifugal water separator.

In accordance with the embodiment of FIG. 2, the mid-pressure water collector assembly 202 includes a circular finned coalescer 214. The circular finned coalescer 214, in accordance with embodiments of the present disclosure, is arranged upstream from the water separator 212. The circular finned coalescer 214 is configured to cause moisture that is contained within treated, moist air 216 that is received from the first stage turbine 206 to condense and/or coalesce into droplets or the like. The condensed or coalesce water may then be captured by the water collector 212 and removed from the airflow, thus providing a treated and dried air 218 to the second stage turbine 208.

The circular finned coalescer is configured with a series or set of parallel fin layers that are separated by thin, cylindrically formed parting sheets. The parting sheets may be wrapped and defined/formed to apply an outward radial spring force to support the fin layers, as shown and described herein. The fin layers, supported on and between the parting sheets may be installed within a support housing that contains and houses the assembly therein. The support housing may be part of the straight section 210 of the duct 204. As the moist air 216 enters and flows through the circular finned coalescer 214, the moisture will impinge upon surfaces of the circular finned coalescer 214 to form into water droplets. The water droplets may then be carried through the circular finned coalescer 214 and enter the water separator 212 where the droplets are removed from the airflow such that the treated and dried air 218 is output from the water separator 212 and supplied into the second stage turbine 208.

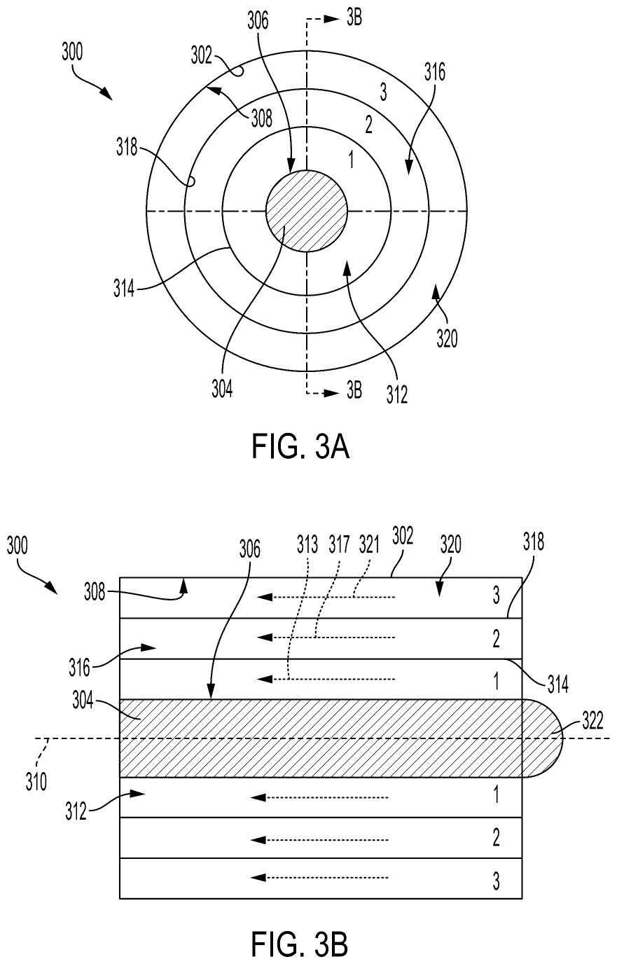

Referring now to FIGS. 3A-3B, schematic illustrations of a circular finned coalescer 300 in accordance with an embodiment of the present disclosure are shown. The circular finned coalescer 300 may be used within an air cycle machine and/or environmental control system of an aircraft, such as in the systems shown and described above. The circular finned coalescer 300 is configured to be installed within or along a duct at a mid-pressure location, such as between a first stage turbine and a second stage turbine of an air cycle machine. FIG. 3A is an end-on illustration of the circular finned coalescer 300 and FIG. 3B is a cross-sectional view along the line 3B shown in FIG. 3A.

The circular finned coalescer 300 includes a housing 302 and a central body 304. The central body 304 and the housing 302 are substantially circular or cylindrical in shape, with the central body 304 arranged within the housing 302. Between an external surface 306 of the central body 304 and an internal surface 308 of the housing 302, the circular finned coalescer 300 includes a number of parting sheets and a number of fin layers. The circular finned coalescer 300 defines an axis 310 along which the central body 304 and the housing 302 are arranged. The parting sheets and fin layers are arranged as annular structures that wrap about the central body 304. For example, in this illustrative configuration, the circular finned coalescer 300 includes a first fin layer 312 arranged on and wrapped about the external surface 306. Radially outward from the first fin layer 312 is a first parting sheet 314. The first parting sheet 314 is configured to contain the first fin layer 312 and define a first flow path 313 through the first fin layer 312. Radially outward from the first parting sheet 314 is a second fin layer 316, a second parting sheet 318, and a third fin layer 320. The second fin layer 316 defines a second flow path 317, and the third fin layer 320 defines a third flow path 321. The third fin layer 320 is arranged between the second parting sheet 318 and the internal surface 308 of the housing 302. The parting sheets 314, 318 may be formed to apply an outward radial spring force to support the adjacent wrapped fin layers 316, 320.

The central body 304 may include a bullnose element 322. The bullnose element 322 may be integrally formed with the central body 304 or may be a separate element that is attached to the central body 304. The bullnose element 322 is arranged at an upstream end of the central body 304. The bullnose element 322 is provided to smoothly part and direct a flow of moist air into the flow paths 313, 317, 321 defined by the fin layers 312, 316, 320.

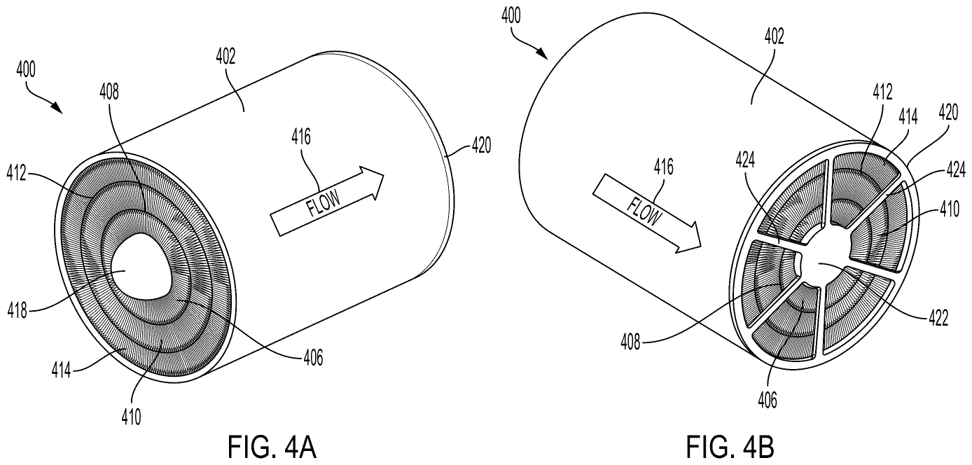

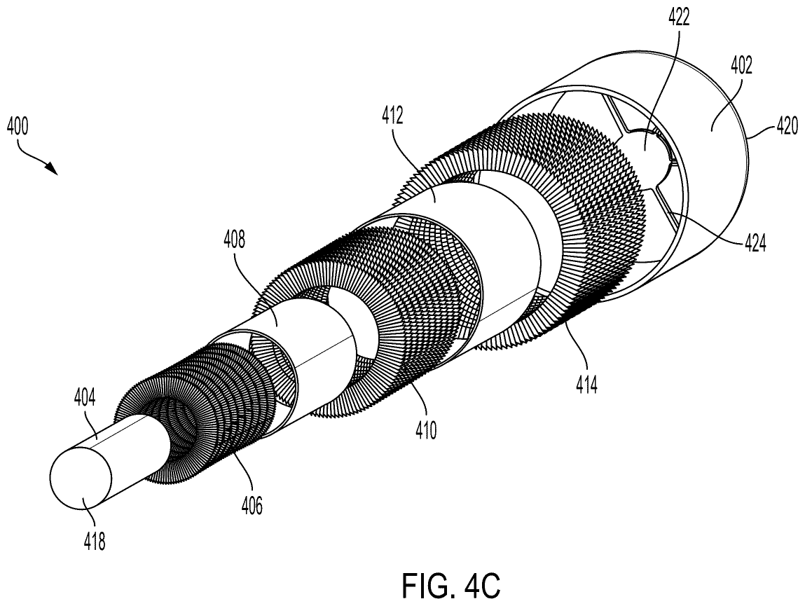

Referring now to FIGS. 4A-4C, schematic illustrations of a circular finned coalescer 400 in accordance with an embodiment of the present disclosure are shown. The circular finned coalescer 400 may be used within an air cycle machine and/or environmental control system of an aircraft, such as in the systems shown and described above. The circular finned coalescer 400 is configured to be installed within or along a duct at a mid-pressure location, such as between a first stage turbine and a second stage turbine of an air cycle machine. FIG. 4A is inlet-end perspective illustration of the circular finned coalescer 400, FIG. 4B is an outlet-end perspective illustration of the circular finned coalescer 400, and FIG. 4C is a partially separated view of the components and features of the circular finned coalescer 400.

The circular finned coalescer 400 includes a housing 402 and a central body 404. The central body 404 and the housing 402 are substantially circular or cylindrical in shape, with the central body 404 arranged within the housing 402. The circular finned coalescer 400 includes a first fin layer 406 arranged on and wrapped about the central body 404. Radially outward from the first fin layer 406 is a first parting sheet 408. Radially outward from the first parting sheet 408 is a second fin layer 410, a second parting sheet 412, and a third fin layer 414. The third fin layer 414 is arranged between the second parting sheet 412 and the housing 402. In FIGS. 4A-4B, a flow through the circular finned coalescer 400 is indicated by arrow 416. Similar to the embodiment shown in FIGS. 3A-3B, the circular finned coalescer 400 includes a bullnose element 418 for directing flow into flow channels or flow paths through the fin layers 406, 410, 414.

As shown in FIGS. 4A-4C, the circular finned coalescer 400 includes a support element 420 arranged at a downstream or outlet end of the housing 402. The support element 420 may be formed as an integral part of the housing 402 or may be a separate element that is arranged at the outlet end of the housing 402. In some embodiments, the support element 420 is fixedly attached to the housing 402. The attachment may be by welding, fasteners, adhesives, bonding, or the like, as will be appreciated by those of skill in the art. As shown, the support element 420 includes a central body support 422 and a set of radial arms 424. The radial arms 424 provide stability and support to the fin layers 406, 410, 414 and the parting sheets 408, 412, at the outlet end thereof. It will be appreciated that the flow of air through the circular finned coalescer 400 will push or urge the structures of the fin layers 406, 410, 414 and the parting sheets 408, 412 toward the support element 420 and thus retain the fin layers 406, 410, 414 and the parting sheets 408, 412 within the housing 402.

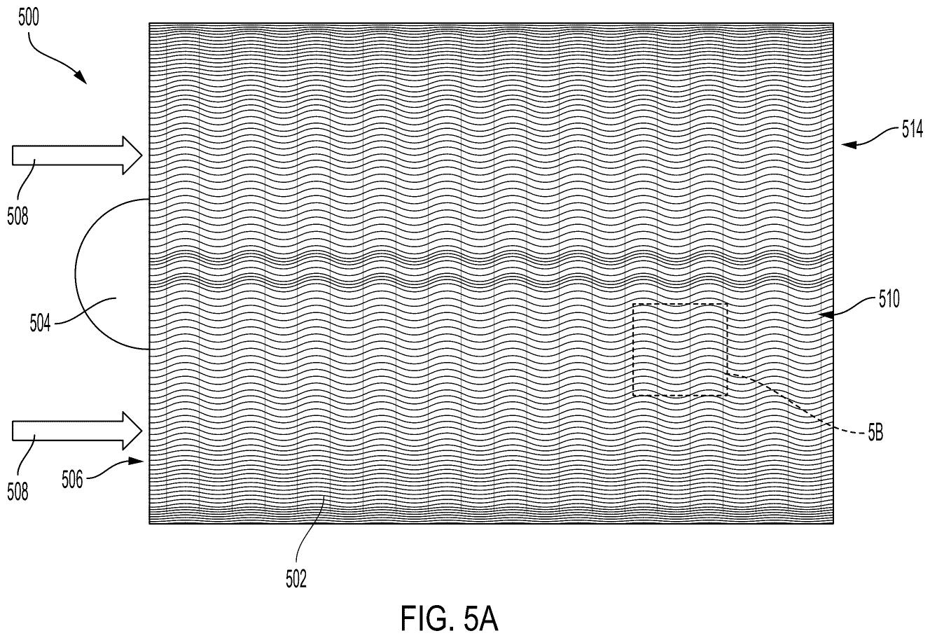

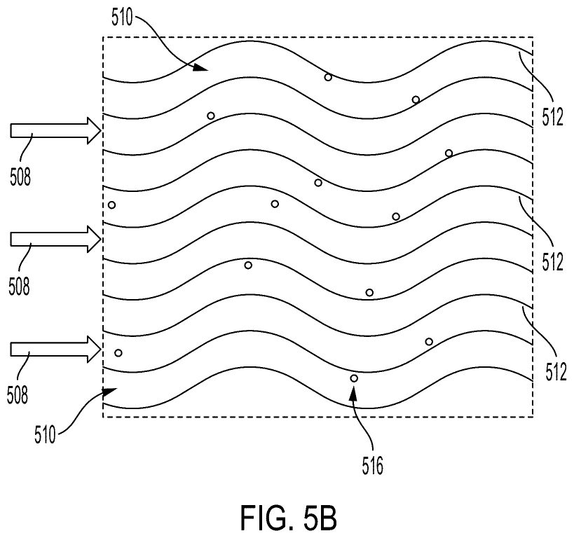

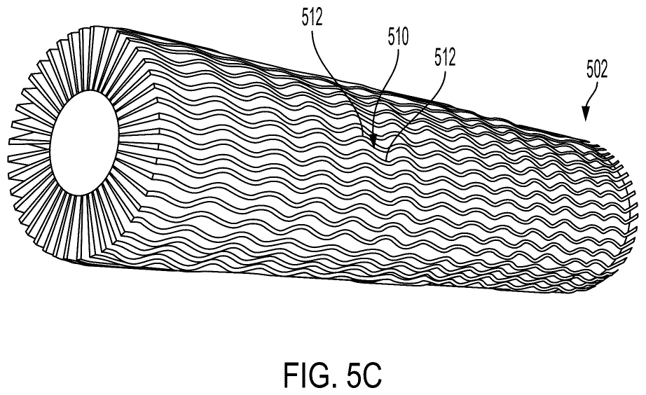

Referring now to FIGS. 5A-5C, schematic illustrations of parts of a circular finned coalescer 500 in accordance with an embodiment of the present disclosure are shown. FIG. 5A illustrates a side view of the circular finned coalescer 500 without a housing, FIG. 5B illustrates an enlarged detailed illustration of the view labeled 5B in FIG. 5A, and FIG. 5C illustrates one fin layer 502 of the circular finned coalescer 500. As shown in FIG. 5A, the circular finned coalescer 500 is formed of one or more fin layers 502 wrapped about a central body, such as shown and described above. As such, each of the fin layers 502 may be a cylindrical structure, similar to that shown and described above. The circular finned coalescer 500 may include a plurality of fin layers 502, which may be wrapped in layers at different radial distances from the central body. In some embodiments, the different fin layers 502 may be separated and/or support on or by parting sheets. In this illustration, the central body includes a bullnose element 504 arranged at an inlet end 506 of the circular finned coalescer 500. In operation, moist air 508 enters the circular finned coalescer 500 at the inlet end 506 and passes through a set of channels 510 defined between fin elements 512 of the fin layer 502.

The fin elements 512 are axially extending sheets of material that extend from the inlet end 506 to an outlet end 514 of the circular finned coalescer 500. The fin elements 512 are arranged as curved or formed elements that define the set of channels 510 between circumferentially adjacent fin elements 512. In a non-limiting example, the channels are substantially sinusoidal flow paths. Because of the curved or tortuous nature of the channels 510, as the moist air 508 flows between the fin elements 512, the moisture will impinge upon the material surfaces of the fin elements 512. As the flow continues along the channels 510 from the inlet end 506 to the outlet end 514, the moisture will coalesce and combine to form droplets or rivulets of water 516. The droplets or rivulets of water 516 may be of sufficient size, weight, and dimension that when they enter a downstream water separator (e.g., as shown in FIG. 2) the water droplets 516 may readily be removed from the airflow such that a relatively dry airflow may be directed downstream into a second stage turbine and then supplied to a part of an aircraft (e.g., cockpit, cabin, etc.).

In accordance with some embodiments of the present disclosure, and those directed to aerospace applications, volume is generally constrained by installation envelope and weight. Accordingly, the size, shape, geometry, dimensions, etc. of the circular finned coalescers described herein may be set based on particular application and implementation requirements and/or limitations. The arrangement of fin layers, as noted above, may be a sinusoidal arrangement to define a tortuous path along which moist air is directed. A minimum of one sine wave may be required to ensure that the moist air impinges upon a surface of the fin layers. That is, in accordance with embodiments, of the present disclosure a direct line of sight flow path from an inlet to an outlet is avoided by implementation of the sinusoidal path provided by the fin layers. The more wave patterns can ensure that droplets of water will collide with the channel walls and thus coalesce. It will be appreciated that each sine cycle (wave shape) can improve the efficiency of the coalescer by providing increased surface area for impingement of moisture onto the walls of the sinusoidal flow paths defined by the fin layers.

It will be appreciated that in accordance with embodiments of the present disclosure, a sinusoidal fin element geometry may be employed with a controlled or predefined amplitude and frequency (which may vary based on design requirements). However, although a sinusoidal geometry is shown and discussed, it will be appreciated that other geometries of the fin layer elements and/or the tortuous flow paths may take other geometric shapes. For example, a stepwise or squared arrangement, a toothed or triangular arrangement, or the like may be employed without departing from the scope of the present disclosure, and the illustrative configurations are merely for explanatory and example purposes and are not intended to be limiting. That is, the tortuous flow paths may be defined by any appropriate geometry shape, with the configuration arranged to ensure that moisture carrying on the airflow will impinge upon and/or coalesce into droplets that can then be removed by a downstream water separator, or the like.

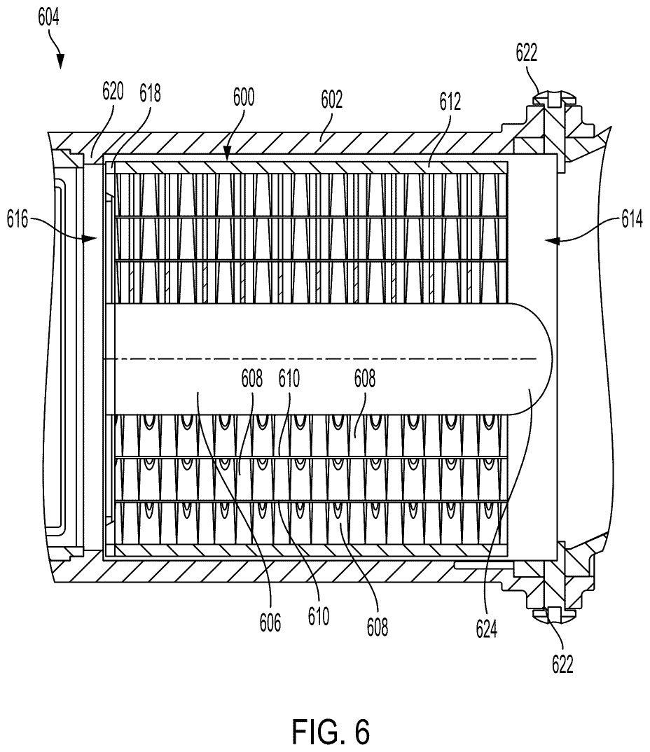

Referring now to FIG. 6, a schematic illustration of a circular finned coalescer 600 installed within a duct 602 of an air cycle machine 604 of an aircraft environmental control system is shown. The circular finned coalescer 600 may be similar to that shown and described above, having a central body 606, with fin layers 608 and parting sheets 610 wrapped about the central body 606. The assembly of the fin layers 608 and the parting sheets 610 are contained within a housing 612. The circular finned coalescer 600 is shown installed within the duct 602. Moist air from a first stage turbine of the air cycle machine 604 is supplied at an inlet end 614 of the circular finned coalescer 600 and air containing droplets of water may exit the circular finned coalescer 600 at an outlet end 616 thereof and enter a water separator (e.g., as shown in FIG. 2).

The circular finned coalescer 600 includes a support element 618 at the outlet end 616 of the housing 612. The support element 618 may be arranged to contact and be supported by a stop 620 arranged within or as part of the duct 602. In some configurations, the circular finned coalescer 600 may be installed and retained within the duct 602 by an interference fit or press fit. In other embodiments, the circular finned coalescer 600 may be secured within the duct 602 by one or more fasteners 622. The fasteners 622 may be arranged to provide a stop at the inlet end 614 of the circular finned coalescer 600. In other configurations, the fasteners 622 may fixedly connect the circular finned coalescer 600 to the duct 602 (e.g., pass through and secure the two elements together). In still other embodiments, welding, bonding, or the like may be used to fixedly secure the circular finned coalescer 600 within the duct 602. In still further embodiments, no mechanical mechanisms may be employed, but rather, the circular finned coalescer 600 may be pushed into or against the stop 620 by the flow of air through the circular finned coalescer 600. That is, as an air flow enters the inlet end 614 of the circular finned coalescer 600, the air flow will apply a force on the elements and features of the circular finned coalescer 600 to engage against the stop 620, thus retaining the circular finned coalescer 600 in place within the duct 602.

As shown and described above, the circular finned coalescer 600 may include a bullnose element 624. The bullnose element 624 is arranged to direct a flow at the inlet end 614 to enter the tortuous paths defined by the fin layers 608 between the parting sheets 610. As the flow enters and passes through channels defined between fin elements of the fin layers 608, the moisture carried by the air flow will impinge upon surfaces of the fin elements and condense or coalesce into water droplets, which may then exit the circular finned coalescer 600 at the outlet end 616. As the droplets and/or rivulets of water exit the circular finned coalescer 600, they will be carried into a water separator that is configured to remove the water from the flow, prior to directly a relatively dry air flow into a second stage turbine of the air cycle machine.

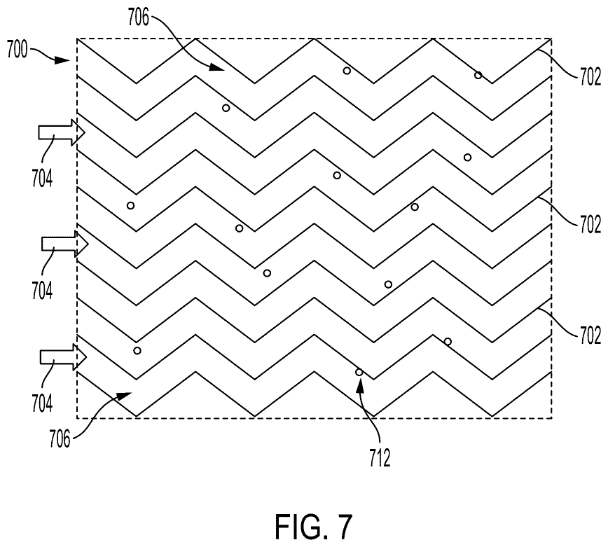

Referring now to FIG. 7, a schematic illustration of a portion of a fin layer 700 for use in a circular finned coalescer in accordance with an embodiment of the present disclosure are shown. As shown in FIG. 7, the fin layer 700 is formed of one or more fin elements 702 arranged in substantially parallel orientation to each other. A formed circular finned coalescer, in accordance with embodiments of the present disclosure, may include a plurality of the fin layers 700, which may be wrapped in layers within a housing. The fin layers 700 may be separated and/or support on or by parting sheets, as shown and described above. In operation, moist air 704 enters the fin layer 700 at an inlet end and passes through a set of channels 706 defined between fin elements 702 of the fin layer 700.

The fin elements 702 are axially extending sheets of material that extend from the inlet end to an outlet end of the fin layer 700 (e.g., as shown in FIGS. 5A-5C). The fin elements 702 are arranged in a saw-tooth configuration or formed elements that define the set of channels 706 between adjacent fin elements 702. In this non-limiting example, the channels 706 are substantially angled or saw-tooth flow paths. Because of the tortuous nature of the channels 706, as the moist air 704 flows between the fin elements 702, the moisture will impinge upon the material surfaces of the fin elements 702. As the flow continues along the channels 706 from the inlet end to the outlet end, the moisture will coalesce and combine to form droplets and/or rivulets of water 712. The water 712 may be of sufficient size, weight, and dimension that when it enters a downstream water separator (e.g., as shown in FIG. 2) the water 712 may readily be removed from the airflow such that a relatively dry airflow may be directed downstream into a second stage turbine and then supplied to a part of an aircraft (e.g., cockpit, cabin, etc.).

In accordance with embodiments of the present disclosure, circular finned coalescers are provided to improve water extraction and removal from an air supply that is processed for delivery to occupied spaces of an aircraft (e.g., cabin, cockpit, etc.). The circular finned coalescers are formed of a series of parallel fin layers separated by thin, cylindrically formed parting sheets. In accordance with some embodiments, the wrapped parting sheets are configured to apply an outward radial spring force to support adjacent wrapped fin layers. The fin layers are formed of thin sheet material that define tortuous parallel channels that extend from an inlet end to an outlet end of the circular finned coalescer.

To assemble the circular finned coalescers, the fin layers and parting sheets are wrapped about a central body and installed within a housing that contains and fin layers and parting sheets. The fin layers and parting sheets may be mechanically trapped within the housing, or may be bonded, brazed, fixed by fasteners, or the like.

The specific features of the circular finned coalescers may be set based on a particular application or system configuration. For example, a fin height, channel spacing, number of layers, and fin wave geometry can be adjusted to achieve a desired coalescence of the moisture output by a first stage turbine. The surface area, channel geometry, pressure drop (from inlet end to outlet end), and flow velocity are examples of features and characteristics that may be considered when designing a circular finned coalescer in accordance with the present disclosure. A bullnose element may be provided at the inlet end of the circular finned coalescer to direct flow into the channels defined by the fin layers. In accordance with some non-limiting embodiments of the present disclosure, the fin layers and/or the parting sheets may be formed from aluminum or other metal or composite materials. In some non-limiting examples, the fin layers may be formed of sheets of material having dimensions of 0.002-0.004 inch thickness and the parting sheets may be formed of material having a thickness of 0.010-0.020 inch. It will be appreciated that thinner or thicker material layers may be used without departing from the scope of the present disclosure, with such thicknesses based on material choices, size and geometry of the circular finned coalescers, system requirements, operational parameters, and the like. In accordance with some embodiments, the fin layers may be trimmed on a bias to impart a swirl into the outlet flow from the circular finned coalescer, which can minimize or eliminate the need for a separate downstream swirler in a water collector.

Advantageously, embodiments described herein provide for improved water removal in aircraft environmental control systems. In accordance with embodiments of the present disclosure, circular finned coalescers are provided to enable passive water coalescence within a duct of an air cycle machine, such as between a first stage turbine and a second stage turbine of the air cycle machine. Embodiments of the present disclosure provide improved water removal techniques while also reducing the number of components in an aircraft environmental control system. Embodiments of the present disclosure can eliminate the need for a crossflow heat exchanger to be used upstream of a water collector, thus simplifying the air cycle machine systems. Further, by eliminating such a heat exchanger, total weight and volume may be reduced as compared to system that rely upon a heat exchanger or other additional components and systems.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8%, or 5%, or 2% of a given value or other percentage change as will be appreciated by those of skill in the art for the particular measurement and/or dimensions referred to herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description but is only limited by the scope of the appended claims.

What is claimed is:

1. An aircraft air cycle machine comprising:
a first stage turbine configured to receive and expand air;
a second stage turbine configured to receive air from the first stage turbine;
a duct arranged between the first stage turbine and the second stage turbine; and
a circular finned coalescer arranged within the duct, the circular finned coalescer comprising:
a central body;
a first fin layer wrapped about the central body;
a first parting sheet wrapped about the first fin layer; and
a second fin layer wrapped about the first parting sheet,
wherein each of the first fin layer and the second fin layer comprise a plurality of fin elements arranged in substantially parallel orientation relative an axis through the central body, and channels are defined between circumferentially adjacent fin elements of the plurality of fin elements of each of the first fin layer and the second fin layer, and
wherein the channels are tortuous channels such that moisture carried on a flow through the channels will impinge upon surfaces of the fin elements and coalesce into water droplets.

2. The aircraft air cycle machine of claim 1, wherein the circular finned coalescer further comprises a bullnose element arranged on an inlet end of the central body, the bullnose element configured to direct flow into the channels defined by the first and second fin layers.

3. The aircraft air cycle machine of claim 1, wherein the circular finned coalescer further comprises a housing, wherein the central body, the first fin layer, the first parting sheet, and the second fin layer are arranged within the housing.

4. The aircraft air cycle machine of claim 3, wherein the housing is configured to securely fit within the duct.

5. The aircraft air cycle machine of claim 3, wherein the duct comprises a stop, and wherein the housing is positioned against the stop.

6. The aircraft air cycle machine of claim 3, wherein the housing is fixedly attached to the duct.

7. The aircraft air cycle machine of claim 1, wherein the circular finned coalescer further comprises:
a second parting sheet wrapped about the second fin layer; and
a third fin layer wrapped about the second parting sheet.

8. The aircraft air cycle machine of claim 7, wherein the circular finned coalescer further comprises:
a housing, wherein the third fin layer is arranged between the second parting sheet and the housing.

9. The aircraft air cycle machine of claim 1, further comprising a water collector arranged between the circular finned coalescer and the second stage turbine.

10. The aircraft air cycle machine of claim 1, wherein each fin layer is formed from a sheet material having a thickness of 0.002-0.004 inch.

11. The aircraft air cycle machine of claim 1, wherein the parting sheet is formed of a sheet material having a thickness of 0.010-0.020 inch.

12. An aircraft environmental control system comprising:
a heat exchanger assembly configured to receive ram air along a first path of the heat exchanger assembly and compressed air along a second path of the heat exchanger assembly, wherein the first path comprises a compressed air inlet on a first heat exchanger, and the compressed air is directed into the compressed air inlet, the compressed air being directed from the first heat exchanger into a second heat exchanger; and
an air cycle machine configured to receive the compressed air from an outlet of the second heat exchanger, wherein the air cycle machine comprises:
a first stage turbine configured to receive and expand the compressed air received from the second heat exchanger;
a second stage turbine configured to receive air from the first stage turbine;
a duct arranged between the first stage turbine and the second stage turbine; and
a circular finned coalescer arranged within the duct, the circular finned coalescer comprising:
a central body;
a first fin layer wrapped about the central body;
a first parting sheet wrapped about the first fin layer; and
a second fin layer wrapped about the first parting sheet,
wherein each of the first fin layer and the second fin layer comprise a plurality of fin elements arranged in substantially parallel orientation relative an axis through the central body, and channels are defined between circumferentially adjacent fin elements of the plurality of fin elements of each of the first fin layer and the second fin layer, and
wherein the channels are tortuous channels such that moisture carried on a flow through the channels will impinge upon surfaces of the fin elements and coalesce into water droplets.

13. The aircraft environmental control system of claim 12, further comprising a water collector arranged between the circular finned coalescer and the second stage turbine.

14. The aircraft environmental control system of claim 12, wherein treated air that is output from the second stage turbine is directed to an enclosure of an aircraft.

15. The aircraft environmental control system of claim 14, wherein the enclosure is one of a cockpit and a cabin of the aircraft.

16. The aircraft environmental control system of claim 12, wherein the circular finned coalescer further comprises a bullnose element arranged on an inlet end of the central body, the bullnose element configured to direct flow into the channels defined by the first and second fin layers.

17. The aircraft environmental control system of claim 12, wherein the circular finned coalescer further comprises a housing, wherein the central body, the first fin layer, the first parting sheet, and the second fin layer are arranged within the housing.

18. The aircraft environmental control system of claim 12, wherein the circular finned coalescer further comprises:
a second parting sheet wrapped about the second fin layer; and
a third fin layer wrapped about the second parting sheet.

19. The aircraft environmental control system of claim 12, wherein each fin layer is formed from a sheet material having a thickness of 0.002-0.004 inch.

20. The aircraft environmental control system of claim 12, wherein the parting sheet is formed of a sheet material having a thickness of 0.010-0.020 inch.
